(19) United States
(12) Patent Application Publication
(10) Pub. No.: US 2004/0127160 A1
(43) Pub. Date: Jul. 1, 2004

(54) Determining neighbour lists

(76) Inventor: Jani Moilanen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/331,942

(22) Filed: Dec. 31, 2002

(51) Int. Cl. H04B 17/00

(52) U.S. Cl. 455/67.11; 455/67.14; 455/422.1

(57) ABSTRACT

A method and system for compiling neighbour lists in a mobile communication network is described. A test signal is transmitted from one base station (BTS) to a set of location measurement units (LMU), one LMU preferably being associated with the transmitting BTS. The received signal is time stamped at each LMU and the transmission times calculated from the time stamps. The transmission times are compared and the list is compiled from those LMUs with close or the same transmission times.

### FIELD OF THE INVENTION

The present invention relates to a method of compiling a list of usable neighbour location measurement units (LMU), to a serving measurement location centre for implementing the method and to a computer program.

### BACKGROUND OF THE INVENTION

In a mobile communication network comprising a plurality of base stations, each base station having a location measurement unit associated with it, it is known to determine the location of a mobile station in the network in the following way. Each of two base stations in the network transmit signals to the mobile station and the mobile station determines the observed time difference (OTD) between the arrival of the two signals. The geographical coordinates of the transmitting base station are known by the serving measurement location centre (SMLC) in the network. The geographical coordinates of the base stations can be used to determine a geometrical time difference (GTD). The real time difference (RTD) can be calculated following the equation:

OTD=RTD+GTD.

From this, the location of the mobile station can be calculated. This calculation can be carried out either in the network itself, that is in the serving measurement location centre, or at the mobile. In the latter case, the RTD and the geographical coordinates of the base station are transmitted to the mobile station.

Such a location measurement technique is managed by SMLC in conjunction with the location measurement units associated with the base stations. To achieve reliable measurements of geographic locations of mobile stations, it is important to know which LMUs can usefully be used to carry out the necessary measurement. In current networks supporting location based service, so-called neighbour (nbor) lists are held. These neighbour lists define for each target LMU a group of adjacent LMUs that can be used to make measurements for determining the geographic location of a mobile station. Currently, such neighbour lists are manually created by experienced field engineers and depending on the network configuration can take several weeks. An experienced field engineer must basically determine which adjacent LMUs to a target base station can obtain accurate timing measurement. In order to determine this, a field engineer must determine if received signals by adjacent LMUs suffer from multipath and/or interference. Firstly, an initial neighbour list can be created by a field engineer by analysing the network layout, for example from looking at the distance of the adjacent LMUs to the target base station, antenna directions or width, linear side, typography and frequency plans.

Next, the neighbour list can be verified by analysing measured signals from adjacent LMUs to the target base station. Verification of this list can be carried out by analysing signal measurements collected by adjacent LMUs, by looking at signal strength, bit error rate and optimisation measurements, for example.

Not only is such a technique time consuming and labour intensive, but it also needs to be carried out each time there is a change in the network, for example frequency re-allocation or deployment of new equipment.

It is an object of the invention to enable a list of usable location measurement units to be compiled without reliance on manual activities and personal expertise.

### SUMMARY OF THE INVENTION

One aspect of the invention provides a method of compiling a list of usable neighbour location measurement units in a mobile communications network comprising a plurality of base stations, each base station having a location measurement unit associated therewith, the method comprising:

(a) transmitting a test signal from one of said base stations;

(b) receiving said test signal at each of a set of said location measurement units and time stamping the test signal with the arrival time at each location measurement unit;

(c) determining from the arrival time at each location measurement unit and its distance from the transmitting base station the transmission time;

(d) comparing the transmission times determined for each of the location measurement units and placing on the list only those location measurement units whose transmission times fall in a predetermined range of one another.

Another aspect of the invention provides a serving measurement location centre in a mobile communications network having a plurality of base stations, each base station having a location measurement unit associated therewith, the centre comprising:

a processor arranged to generate an instruction to one of the base stations to transmit a test signal and to receive from each of a set of the location measurement units receiving the test signal a transmission time calculated at the respective measurement units;

a store holding a list of useful location measurement units;

said processor being programmed to compare the transmission times determined at each of the location measurement units and to place on the list only the location measurement units whose determined transmission times fall in a predetermined range of one another.

A further aspect of the invention provides a computer program product comprising program code means which when executed on a processor cause the processor to generate an instruction to each of a plurality of base stations in a network to cause the base station to transmit a test signal, and to receive from each of a set of location measurement units associated with the base stations a transmission time calculated at the respective location measurement unit, and to further cause the processor to compare the transmission times determined at each of the location measurement units and to place on a list of usable neighbour location measurement units only those whose transmission times fall in a predetermined range of one another.

Preferably, the method steps are carried out for each of the base stations in the network in a predetermined sequence and at predetermined time intervals. By automating compilation of the neighbour lists, it is possible to compile them periodically, for example at night when traffic in the networks is low, without involving a huge amount of work, time and expertise. Thus, the neighbour list are “self-defined” without action by a user, and because they can easily be done periodically in an automated fashion, they can take into account continuing changes in the network.

For a better understanding of the invention and to show how the same may be carried into effect reference will now be made by way of example to the accompanying drawings.

### BRIEF DESCRIPTION OF THE DRAWINGS

FIG. 1 is a schematic block diagram of relevant components of a mobile communication network;

FIG. 2 is a schematic diagram illustrating the LMU candidate measurement technique;

FIG. 3 is a diagram illustrating a neighbour list;

FIG. 4 is a diagram illustrating frame structure for a radio signal;

FIG. 5 is a schematic diagram illustrating a serving measurement location centre; and

FIG. 6 is a flow chart illustrating process steps to obtain the neighbour list.

### DESCRIPTION OF THE PREFERRED EMBODIMENT

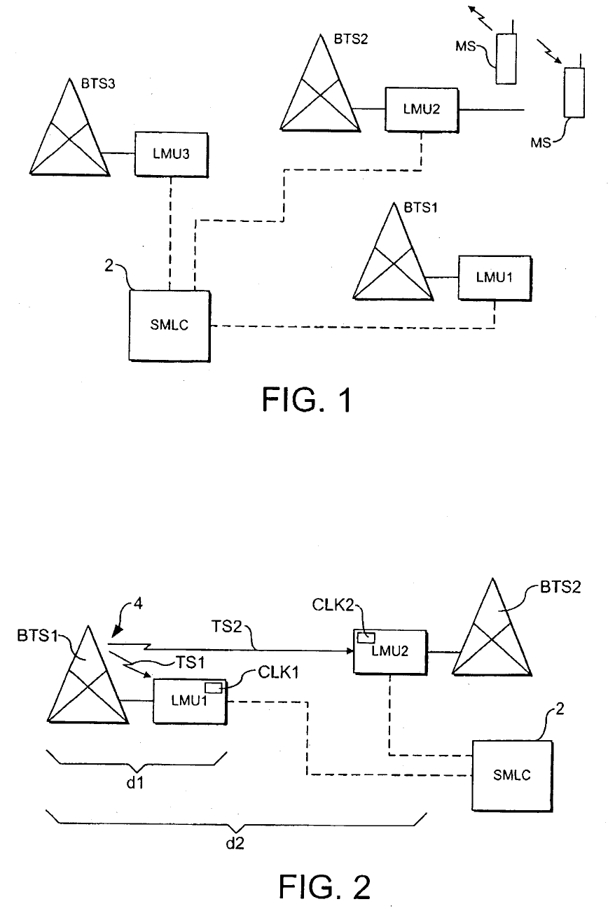

FIG. 1 is a schematic diagram of the relevant components of a mobile communication network. The network comprises a plurality of base stations, three of which are illustrated referenced BTS1, BTS2, BTS3. It will be apparent that there will be a large number of base stations in the network, organised in any known way. At least some, if not all, base stations in the network are associated with respective location measurement units (LMUs), referenced herein LMU1, LMU2 and LMU3 corresponding to the appropriate base stations. A serving measurement location centre ML 2 is located in the network and is in communication with the location measurement units. This communication can be via a fixed line or a radio channel. Each location measurement unit LMU is connected to its associated base station in such a manner that it can cause the base stations to transmit signals, and also can receive signals either transmitted from their own associated base station or from other base stations. For the purpose of receiving signals each LMU is equipped with a receiver for receiving radio signals across the air interface. It will also be apparent that there will be a number of mobile stations in the network, in communication with the base stations via radio signals. By way of example, two mobile stations MS1, MS2 are illustrated.

In order to determine the location of a mobile station in the network, it is known to transmit radio signals from a pair of base stations and to compare the arrival times of the signals at the mobile station to generate an observed time difference OTD. This information is then utilized with information relating to the geographical coordinates of the base stations to determine the real time difference (RTD) between the signals and thus the real location of the mobile station. Techniques for location measurement are not further discussed herein, because they are known and do not form part of the present invention. What is important, however, is that it is necessary to use a pair of base stations which provide the best possible signals for locating the mobile. To that end, each base station and its associated LMU need to have a list of neighbouring LMUs and base stations, a so-called neighbour (nbor) list, which indicates which pairs of base stations can readily be utilized in any particular circumstance. This neighbour list is stored at the SMLC as will become clearer later.

FIG. 2 is a schematic diagram illustrating how a neighbour list can be automatically compiled. FIG. 2 illustrates a first base station BTS1 associated with a first location measuring unit LMU1, and a second base station BTS2 associated with a second location measuring unit LMU2. The distance d₁ is the distance between the first base station BTS1 and the first location measuring unit LMU1. d₂ is the distance between the first base station BTS1 and the second location measuring unit LMU2. These distances are held at the SMLC 2. Each location measuring unit LMU1, LMU2 is provided with an internal clock CLK1, CLK2 which are controlled using some global timing system, for example GPS. It is important that these clocks are accurate and synchronized. The first base station BTS1 is instructed by the SMLC 2 to transmit a test signal 4 which is received by the first location measuring unit LMU1 along path TS1 and by the second location measurement unit LMU2 along path TS2. The time stamps at these location measurement units are referred to herein as AT. The time stamp at LMU1 is AT1 and the time stamp at LMU2 is AT2. The transmission time (absolute time AT) from the first base station BTS1 can be calculated at each of the location measuring units using the formula.

AT=AT−d/c,

where d is the distance d₁ or d₂ accordingly, and c is the speed of radio waves in air, and AT is the corresponding time stamp AT1 or AT2 respectively. The correspondingly obtained transmission times AT1, AT2 are compared with each other at the SMLC 2. If they are the same, this means that both of the transmission paths TS1, TS2 for the test signal 4 are direct line of sight paths without excessive multipath effects or interference. Of course, there may be a small difference between the determined transmission times, due to errors etc and it is necessary to determine a predetermined range of differences that is satisfactory. Once this range has been determined, the SMLC 2 can automatically accept or reject candidate LMUs for the neighbour list based on these results.

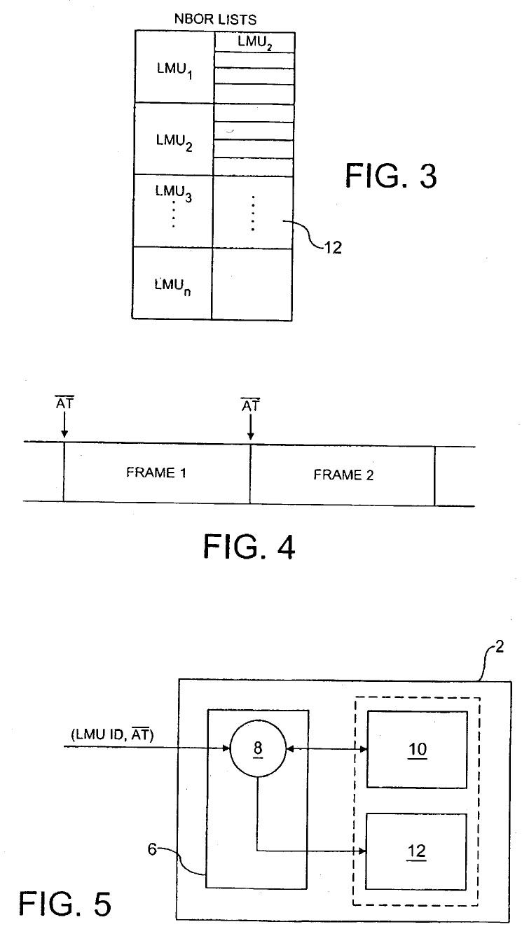

FIG. 2 illustrates a situation where a test signal 4 is sent to two LMUs. Of course, it is possible to send the test signal simultaneously to any number of LMUs and to compare the results from any of these LMUs. FIG. 3 illustrates the neighbour lists 12 for each LMU The LMUs on the left hand side are considered to be the target LMU in each case, and the list of possible candidate LMUs on the right hand side are its acceptable neighbours or useful neighbours. The procedure described above can be implemented for each base station in turn to determine the neighbour lists. That is, transmission of the test signal from the first base station BTS1 determines the neighbour list for LMU1. Transmission of a test signal from the second base station BTS2 would determine the neighbour list for the location measuring unit LMU2 and so on.

As is known, radio signals in a communication network generally have a frame structure, each frame containing data symbols and control symbols and having a certain frame length. Such a frame structure is illustrated in FIG. 4. To improve the accuracy of the measurements, the time stamping carried out at the LMUs can be carried out for a sequence of measurements, with the measured time taking into account the frame times. In this way, the accuracy of the received time, and consequently the calculated transmission time can be improved. It is also possible to take a number of results of the transmission time from a sequence of test signals and to take an average of them, once again to improve the reliability of the results.

FIG. 5 is schematic flow diagram of the relevant components of the SMLC 2. The SMLC 2 includes a microprocessor 6 arranged to execute a computer program 8 for implementing the calculation and comparison steps described above. The SMLC 2 also includes a memory which holds, amongst other things, data 10 defining the distances of each of the location measuring units from the base stations and the neighbour lists denoted 12. The SMLU receives for each measurement the identity of the location measuring unit LMUID together with the time stamp of the test signal AT. The LMUID is used to extract the distance d from the data 10 and the program 8 then calculates the transmission time AT. As data from subsequent LMUs is received, this transmission time is compared with subsequently calculated transmission times and a comparison performed. Accepted LMUs are placed on a neighbour list 12 and rejected LMUs are discarded.

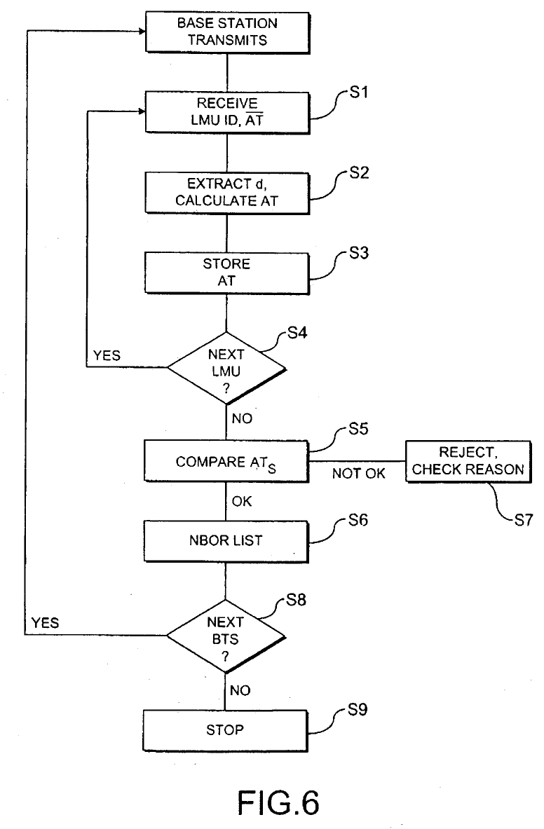

FIG. 6 is a flow chart illustrating the salient points of the method. Note that FIG. 6 does not illustrate the various averaging and multiple measurement steps which would generally take place in a practical implementation to ensure accuracy. At step S0 the first base station is instructed to transmit a test signal. At step S1, the LMUID and the associated time stamp AT is received. At step S2, the distance d is extracted from the data 10 and the transmission time AT is calculated for that LMU. That transmission time is stored at step S3 in the memory of the SMLC 2. A check is carried out at S4 to see whether or not there is a next LMU waiting to send its data. If so, the steps S1 to S3 are carried out again. If not, the transmission time which has been calculated is compared with the transmission time calculated for earlier LMUs. If the result is OK, that is they are the same or within a small predetermined range, that LMU is placed on the neighbour list for the transmitting base station If it is not OK, it is rejected and reasons for that rejection might then be checked. A check is then carried out at step S8 to see whether all the base stations which are to be included in the survey have been included. If they have not, then the next base station is caused to transmit a test signal (step S0). If they have, the process is stopped at step S9.

If there is a systematic error in the calculated transmission times AT for a particular pair of LMUs, it may be possible to use that systematic error as a correction parameter so that the pair can still be considered neighbours, but with the application of that constant parameter. This could mean for example that there is a persistent but constant reflection in the path.

Also, the method can be used for checking the coordinates of base stations. If none of the LMUs can measure certain base stations, that is the calculated transmission times never come close to each other, then it probably means there is something wrong with the distances which have been given for the calculations, and consequently something wrong with the coordinates for the base station.

What is claimed is:

1. A method of compiling a list of usable neighbour location measurement units in a mobile communications network comprising a plurality of base stations, each base station having a location measurement unit associated therewith, the method comprising:
(a) transmitting a test signal from one of said base stations;
(b) receiving said test signal at each of a set of said location measurement units and time stamping the test signal with the arrival time at each location measurement unit;
(c) determining from the arrival time at each location measurement unit and its distance from the transmitting base station the transmission time;
(d) comparing the transmission times determined for each of the location measurement units and placing on the list only those location measurement units whose transmission times fall in a predetermined range of one another.

2. A method according to claim 1, wherein steps (a) to (d) are carried out for each base station.

3. A method according to claim 2, when carried out for a predetermined sequence of base stations at predetermined time intervals.

4. A method according to claim 2, when carried out using a computer program executed on a processor.

5. A method according to claim 2, when carried out at a serving location measurement centre in the network.

6. A method according to claim 1, wherein said time stamping is carried out using a global clock.

7. A serving measurement location centre in a mobile communications network having a plurality of base stations, each base station having a location measurement unit associated therewith, the centre comprising:
a processor arranged to generate an instruction to one of the base stations to transmit a test signal and to receive from each of a set of the location measurement units receiving the test signal a transmission time calculated at the respective measurement units;
a store holding a list of useful location measurement units;
said processor being programmed to compare the transmission times determined at each of the location measurement units and to place on the list only the location measurement units whose determined transmission times fall in a predetermined range of one another.

8. A serving-measurement location centre according to claim 7, wherein the processor is arranged to generate said instruction for each of the base stations.

9. A serving measurement location centre according to claim 8, wherein the processor is arranged to generate said instructions for a predetermined sequence of base stations at predetermined time intervals.

10. A computer program product comprising program code means which when executed on a processor cause the processor to generate an instruction to each of a plurality of base stations in a network to cause the base station to transmit a test signal, and to receive from each of a set of location measurement units associated with the base stations a transmission time calculated at the respective location measurement unit, and to further cause the processor to compare the transmission times determined at each of the location measurement units and to place on a list of usable neighbour location measurement units only those whose transmission times fall in a predetermined range of one another.
